(19) United States
(12) Patent Application Publication
(10) Pub. No.: US 2026/0247152 A1
(43) Pub. Date: Aug. 20, 2026

(54) Device, Transmission Unit and Method for Sending Messages, Device, Transmission Unit, and Method for Receiving Messages, Vehicle Having the Transmission Unit or the Devices

(71) Applicant: Robert Bosch GmbH, Stuttgart (DE)

(72) Inventors: Andreas Riedinger, Freiburg (DE); Jochen Steinmetz, Neckarwestheim (DE)

(21) Appl. No.: 19/126,404

(22) PCT Filed: Oct. 24, 2023
(86) PCT No.: PCT/EP2023/079586

§ 371 Date: May 1, 2025

(30) Foreign Application Priority Data
Nov. 2, 2022 (DE) 10 2022 211 585.6

(51) Int. Cl. H04W 12/106; H04W 4/40

(52) U.S. Cl. CPC H04W 12/106; H04W 4/40

(57) ABSTRACT

A method for sending messages includes sending a plurality of messages. The method also includes determining a reference message authentication code according to at least two messages of the plurality of messages, for which a receipt confirmation is received. According to the method, the reference message authentication code is sent.

### PRIOR ART

The invention relates to a device and method for sending messages, a device and a method for receiving messages, and a vehicle comprising the devices.

Message authentication codes (MAC) are already used in communication between different control devices to ensure an integrity of the data transmitted in the messages and their authenticity.

### DISCLOSURE OF THE INVENTION

The methods and devices and the vehicle according to the independent claims reduce a processor load and a bus load when transmitting the messages.

A method for sending messages provides that a plurality of messages is sent, wherein a reference message authentication code, in particular a message authentication code, is determined according to at least two messages from the plurality of messages, for which a receipt confirmation is received, and wherein the reference message authentication code is sent. This reduces a bandwidth on a medium for communication, e.g., on a data bus.

Preferably, a penultimate hash value is determined according to a penultimate message from the plurality of messages using a hash function, wherein a last hash value is determined using the hash function according to a last message from the plurality of messages and the penultimate hash value, and the reference message authentication code is determined according to the last hash value. That is, the reference message authentication code is determined according to recursively and iteratively determined hash values. This requires less storage capacity.

Preferably, the reference message authentication code is determined independently of at least one message from the plurality of messages for which a receipt confirmation is not received. The messages that are considered have been received by a receiver. The reference message authentication code, which is based on these messages, is verifiable against a match with a message authentication code determined by a receiver.

Preferably, an instruction to initiate a response is sent.

Preferably, a message comprising the reference message authentication code is determined, and wherein said message is transmitted at least once, in particular until a receipt confirmation for said message is received for the first time. This enables the verification of integrity and authenticity for the receiver. By terminating the transmission of the reference message authentication code upon receipt of a first-time receipt confirmation, the load on the medium is reduced or minimized.

A first transmission unit is configured to perform the method of sending. This has advantages corresponding to those of the method for sending.

A first device, in particular a steering control unit or control device, comprises a first transmission unit configured to perform the method for sending. This device has advantages corresponding to those of the method for sending.

A method for receiving messages provides that a plurality of messages is received, wherein a message authentication code is determined according to the messages from the plurality of messages.

Preferably, a penultimate hash value is determined according to a penultimate message from the plurality of messages using a hash function, wherein a last hash value is determined using the hash function according to a last message from the plurality of messages and the penultimate hash value, and the message authentication code is determined according to the last hash value.

Preferably, a reference message authentication code is received, wherein it is checked whether the message authentication code and the reference message authentication code match, and wherein a response is initiated when the message authentication code and the reference message authentication code deviate from each other. The hash value is determined recursively and iteratively over the plurality of messages, and the message authentication code is determined according to the hash value. This determines the message authentication code recursively and iteratively. This saves bandwidth and memory resources.

Preferably, an instruction to initiate a response is received and the response is initiated. Thereby, a response, in particular error handling, can be performed based on the message authentication codes.

Preferably, it is checked whether a message comprising the reference message authentication code is received, wherein the message authentication code is determined according to a predetermined number of messages received prior to that message.

A second transmission unit is configured to perform the method for receiving. This has advantages corresponding to those of the method for receiving.

A second device, in particular a steering actuator, comprises a second transmission unit configured to perform the method for receiving. This device has advantages corresponding to those of the method for receiving.

A vehicle comprising the first transmission unit and the second transmission unit and a data bus for transmitting messages connecting the transmission unit has advantages corresponding to those of the devices.

A vehicle comprising the first device and the second device and a data bus for transmitting messages connecting the devices has advantages corresponding to those of the devices.

Further advantageous embodiments will become apparent from the following description and the drawing. The drawings show:

FIG. 1 a schematic illustration of a vehicle,

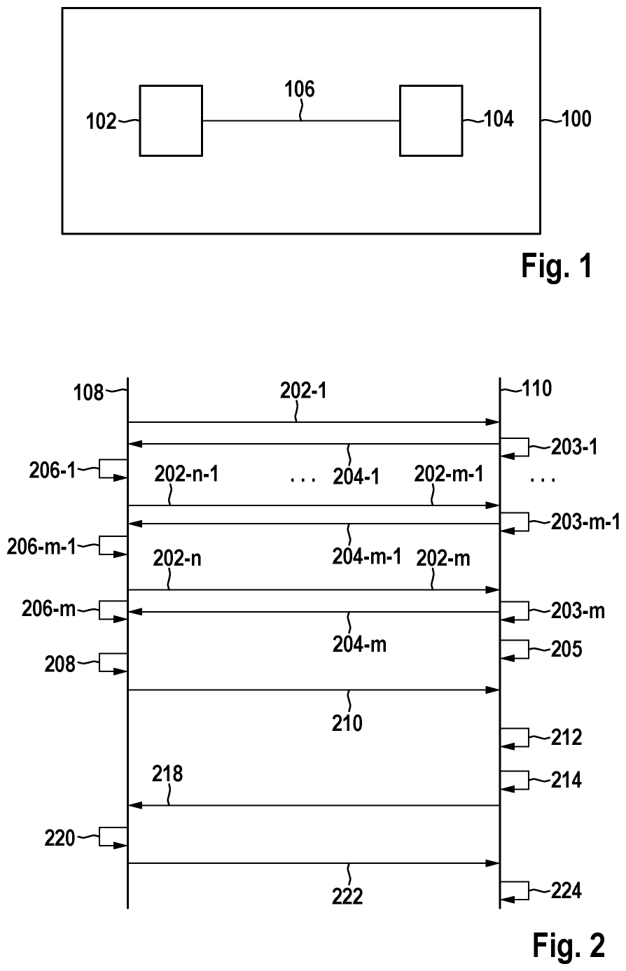

FIG. 2 a sequence diagram,

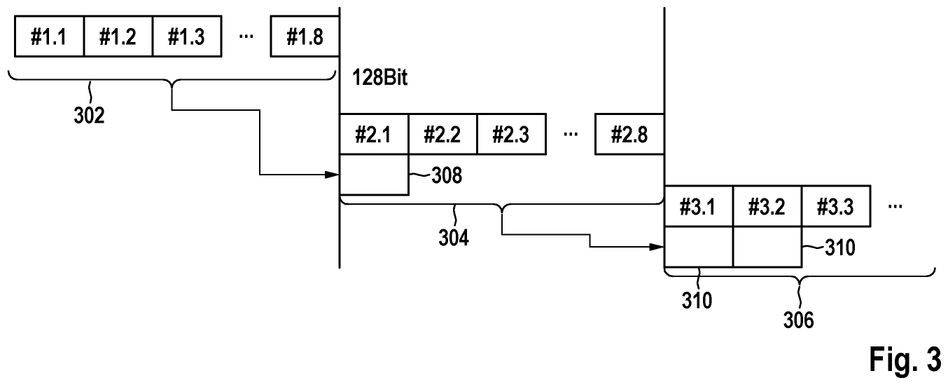

FIG. 3 a schematic illustration of segments for transmitting messages.

A vehicle 100 is shown schematically in FIG. 1.

A vehicle 100 comprising a first device 102. For example, the first device 102 is a steering control unit. The first device 102 may also be another controller for the vehicle 100 or a sensor. For example, the first device 102 comprises, e.g., a vehicle integration platform on which the steering control unit is implemented.

In the example, the first device 102 comprises a control device or is part of a control device.

The vehicle 100 comprises a second device 104. In the example, the second device 104 is a steering actuator. The second device 104 may also be another actuator. In the example, the second device 104 comprises a control device or is part of a control device.

In the example, the steering actuator and the steering control unit are configured to perform a steering function of the vehicle 100. This may comprise, for example, a steering feel or vehicle stability.

The vehicle 100 may comprise further control devices, e.g., for its powertrain or brake, in particular a brake by wire system. The first device 102 and/or the second device 104 may comprise one of these control devices or may be part of one of these control devices.

The first device 102 may be a central control device that performs complex tasks, such as control, in particular steering assistance or steering feel, and calculates and sends control variables to one or more actuators. The actuators may have the task of implementing these control variables as well as sending sensor data to the central control device.

The vehicle 100 comprises a data bus 106 for transmitting messages that connect these devices. The data bus 106 is private in the example, i.e., only one transmitter and only one receiver is connected to the data bus 106.

In order to be able to meet requirements such as driving feel and controller dynamics, both control variables and sensor data must be transmitted at very high frequencies, e.g., 1 kHz, or in real time. Even latencies in the millisecond range lead to a deterioration of the control, in particular of the steering assistance or the steering feel, in the worst case scenario to a loss of control over the steering. The first device 102 and the second device 104 as well as the data bus 106 are configured to meet these requirements.

The first device 102 comprises a first transmission unit 108 configured to perform steps in a method for sending messages described below.

The first transmission unit 108 is configured to group a plurality of messages to be sent into one segment. A segment comprises messages in example 8. More or fewer messages may be grouped into a segment.

The second device 104 comprises a second transmission unit 110 configured to perform steps in the method for receiving messages described below.

The second transmission unit 110 is configured to confirm receipt of a message, in particular by sending an acknowledgment, ACK. For example, the data bus 106 is configured in accordance with the CAN protocol. This provides an acknowledge frame to inform a sending control device that a message has been received by at least one other control device.

The first transmission unit 108 is configured to determine a message authentication code, MAC, for messages from the same segment whose receipt is confirmed by the device 104 for receiving messages. This is also hereinafter referred to as the reference message authentication code. The message authentication code is, e.g., an AES CMAC in accordance with NIST Special Publication 800-38B, in particular with 128 bits.

The second transmission unit 110 is configured to determine a message authentication code for messages from the same segment that are received.

In the example, the first transmission unit 108 and the second transmission unit 110 are configured to determine the hash values using the same hash function. For example, the hash function is configured to determine 64-bit or 256-bit hash values. A hash value in the example is a 64-bit number or a 256-bit number.

In the example, the first transmission unit 108 and the second transmission unit 110 are configured to iteratively and recursively determine the hash value.

In a first iteration, a first hash value is determined according to a first message from a plurality of messages associated with a first segment and an initialization value. In a final iteration, a final hash value is determined. The last hash value is determined according to a hash value from a penultimate iteration and a last message from the plurality of messages associated with the first segment. After the last iteration, the message authentication code is determined according to the last hash value. The initialization value in the example for 64-bit hash values is a 64-bit number or for a 256-bit hash value is a 256-bit number.

The first transmission unit 108 is configured in an example to send the reference message authentication code determined by it. It may be provided not to send the reference message authentication code. In the example, the reference message authentication code for the first segment is sent in a message from a plurality of messages associated with a second segment.

The first transmission unit 108 is configured to send the reference message authentication code determined by it in a message until a receipt confirmation for that message is received. It may be provided that the first transmission unit 108 is configured to send different reference message authentication codes for different segments, each in a message from a plurality of messages associated with a different segment.

The second transmission unit 110 is configured in an example to check whether the received reference message authentication code matches the message authentication code that the second transmission unit 110 determines for the same segment. The second transmission unit 110 is configured in an example to receive the reference message authentication code. The second transmission unit 110 is configured in an example to initiate a response when the reference message authentication code and the message authentication code deviate from each other.

The first transmission unit 108 is configured in an example to send an instruction to initiate a response.

The second transmission unit 110 is configured in an example to receive an instruction to initiate a response and to initiate the response.

FIG. 2 shows a sequence diagram illustrating the steps in the methods and their cooperation.

The following describes a transmission of a plurality of messages from a segment comprising n messages.

In the example, n messages 202-1, . . . , 202-n-1, 202-n are sent from the first transmission unit 108. The messages are sent without being secured by a message authentication code.

In the example, m messages 202-1, . . . , 202-m-1, 202-m are received from the second transmission unit 110.

The second transmission unit 110 iteratively and recursively determines hash values. By way of example, a determination 203-1 of a first hash value according to a first message 202-1 of the plurality of messages, a determination 203-m-1 of a penultimate hash value according to a penultimate message 202-m-1, and a determination 203-m of a last hash value according to a last message 202-m is shown.

In the example, the first message 202-1 and the last message 202-n are received. In a case in which the first message 202-1 and/or the last message 202-n is not received, it is provided to determine the hash value for the respective received messages.

When all n messages are received, m=n hash values are determined. If not all messages are received, i.e., m<n messages are received, the hash values for the received messages are determined.

A receipt confirmation is sent for the received messages. In the example, the receipt confirmations 204-1, . . . , 204-m-1, 204-m are sent after receiving the respective message 202-1, . . . , 202-m-1, 202-m.

In a step 205, the message authentication code is determined according to the final hash value.

In a step 208, the first transmission unit 108 determines the reference message authentication code, in particular the message authentication code. The reference message authentication code is determined in the example according to the sent messages for which a receipt confirmation is received.

The first transmission unit 108 recursively and iteratively determines hash values. By way of example, a determination 206-1 of a first hash value according to the first sent message 202-1, a determination 206-m-1 of a penultimate hash value according to the penultimate sent message 202-n-1, and a determination 206-m of a last hash value according to a last sent message 202-n is shown.

In the example, the first sent message 202-1, the penultimate sent message 202-n-1, and the last sent message 202-n are received. In a case in which the first sent message 202-1 and/or the penultimate sent message 202-n-1 and/or the last sent message 202-n is not received, it is provided to determine the hash value for the respective received messages of the sent messages.

When all n sent messages are received, m=n hash values are determined. If not all sent messages are received, i.e., m<n messages are received, the hash values are determined for the sent messages that are also received, i.e., for which the receipt confirmation is received.

The reference message authentication code is determined according to at least two messages from the plurality of messages. In the example, the reference message authentication code is determined with the last of the hash values.

When all n sent messages are received, the reference message authentication code is determined according to the m=n hash values. If not all sent messages are received, i.e., m<n messages are received, the reference message authentication code is determined according to the hash values for the sent messages that are received.

If not all sent messages are received, the reference message authentication code is determined independently of at least one message from the plurality of messages for which a receipt confirmation is not received.

In a step 210, the reference message authentication code is sent. For example, the message comprising the reference message authentication code is determined. The reference message authentication code is sent in an example in the message. In an example, the reference message authentication code of the segment is sent in a message from a next segment.

In a step 212, the second transmission unit 110 checks whether the reference message authentication code and the message authentication code match.

If they are different, in an example a response is initiated in a step 214.

In a step 218, a status message is sent from the second transmission unit 110 for that message and received from the first transmission unit 108.

For example, in a step 220, a message comprising the instruction to initiate a response is determined. The instruction is sent in an example in a message 222. In an example, the instruction for the segment in a message is sent from a next segment.

In a step 224, in an example a response is initiated when the instruction to initiate a response is received.

It may be provided that second transmission unit 110 checks whether a message comprising the reference message authentication code is received. It may be provided that when this message is received, the message authentication code is determined according to a predetermined number of messages received prior to this message. The predetermined number in the example is a number of messages sent in the segment. For example, if the segment comprises n=8 messages, the message authentication code is determined according to the predetermined number of m=8 messages.

It may be provided to proceed as described for the segment for further segments.

For example, in order to ensure integrity of multiple messages having only one MAC, a hash value is used that is formed from multiple messages and acts as a type of fingerprint of that message sequence.

This fingerprint is used to calculate and verify the MAC. In order for the hash value to also be calculated correctly by the recipient, only m successfully transmitted messages are included in the calculation of the hash value in the example.

In the example, the hash value is iteratively calculated after each sending/receiving operation so that buffering of a plurality of messages can be omitted.

In an example, the calculated MAC value is transmitted to the second device 104, i.e., a receiver control device, immediately after its calculation. Since it cannot know how many messages were transmitted incorrectly, it interprets the received MAC in an example as an end of a message sequence of m messages. The second device 104 calculates in an example the hash value of these m messages and subsequently verifies the MAC. Messages received after the received MAC are interpreted as part of a new message sequence. This implementation is particularly advantageous, as the transmission of an additional message counter can thereby be omitted.

FIG. 3 shows an example of segments for transmitting messages.

In a first segment 302, 8 messages #1.1, #1.2, #1.3, . . . , #1.8 are arranged. In a second segment 304, 8 messages #2.1, #2.2, #2.3, . . . , #2.8 are arranged. In a third segment 306, 8 messages #3.1, #3.2, #3.3, . . . are arranged.

A first reference message authentication code 308 of the first segment 302 in the example is a 128-bit MAC and is sent in a first message #2.1 of the second segment 304. A second reference message authentication code 310 of the second segment 304 in the example is a 128-bit MAC and is sent in a first message #3.1 of the third segment 306. In an example, if the receipt confirmation for the first message #2.1 of the second segment 304 is received, resending the first reference message authentication code 308 is omitted. In an example, if the receipt confirmation for the first message #2.1 of the second segment 304 is not received, the first reference message authentication code 308 is resent. In the example, it is shown that the first reference message authentication code 310 is resent in a second message #3.2 of the third segment 306.

It may be provided to detect whether a reference message authentication code of a segment fails often. In that case, it may be provided to take a replacement action. For example, the replacement action is taken by the device 102 to send the messages when it is detected that, despite sending the reference message authentication code multiple times, no receipt confirmation is received for any of the messages comprising the reference message authentication code. For example, the replacement action is taken by the device 104 to receive the messages when it is detected that, despite a predetermined wait time, a message comprising the reference message authentication code is not received.

1. A method for sending messages, comprising:
sending a plurality of messages;
receiving a receipt confirmation;
determining a reference message authentication code according to at least two messages from the plurality of messages, for which the receipt confirmation is received; and
sending the reference message authentication code.

2. The method according to claim 1, further comprising:
determining a penultimate hash value according to a penultimate message from the plurality of messages using a hash function; and
determining a last hash value using the hash function according to a last message from the plurality of messages and the penultimate hash value,
wherein the reference message authentication code is determined according to the last hash value.

3. The method according to claim 1, wherein the reference message authentication code is determined independently of at least one message from the plurality of messages for which the receipt confirmation is not received.

4. The method according to claim 1, further comprising:
sending an instruction to initiate a response.

5. The method according to claim 1, further comprising:
determining a code message comprising the reference message authentication code; and
transmitting the code message until the receipt confirmation for the code message is received for a first time.

6. A transmission unit, comprising:
a controller configured to perform the method according to claim 1.

7. A steering control unit, comprising:
the transmission unit according to claim 6.

8. A method for receiving messages, comprising:
receiving a plurality of messages; and
determining a message authentication code according to messages from the plurality of messages.

9. The method according to claim 8 further comprising:
determining a penultimate hash value according to a penultimate message from the plurality of messages using a hash function; and
determining a last hash value using the hash function according to a last message from the plurality of messages and the penultimate hash value,
wherein a reference message authentication code is determined according to the last hash value.

10. The method according to claim 8, further comprising:
receiving a message of the plurality of messages including the reference message authentication code;
checking whether the message authentication code and the reference message authentication code match; and
initiating a response when if the message authentication code and the reference message authentication code deviate from each other.

11. The method according to claim 8, further comprising:
receiving an instruction to initiate a response; and
initiating the response.

12. The method according to claim 10, further comprising:
checking whether the message is received comprising the reference message authentication code,
wherein the message authentication code is determined according to a predetermined number of messages received prior to that message.

13. A transmission unit, comprising:
a controller configured to perform the method according to claim 8.

14. A steering actuator, comprising:
the transmission unit according to claim 13.

15. A vehicle, comprising:
the steering control unit according to claim 7; and
a data bus for transmitting the messages of the plurality of messages.

16. A vehicle, comprising:
the steering actuator according to claim 14; and
a data bus for transmitting the messages of the plurality of messages.
